(19) United States
(12) Patent Application Publication
(10) Pub. No.: US 2015/0180859 A1
(43) Pub. Date: Jun. 25, 2015

(54) LOGIN REQUESTING DEVICE AND METHOD FOR REQUESTING LOGIN TO SERVER AND STORAGE MEDIUM STORING A PROGRAM USED THEREFOR

(71) Applicant: DeNA Co., Ltd., Tokyo (JP)

(72) Inventors: Hiroyuki Kawakami, Tokyo (JP); Sota Mizushima, Tokyo (JP); Takashi Hirai, Tokyo (JP)

(73) Assignee: DeNA Co., Ltd.

(21) Appl. No.: 14/576,046

(22) Filed: Dec. 18, 2014

(30) Foreign Application Priority Data
Dec. 20, 2013 (JP) 2013-263744

(51) Int. Cl. H04L 29/06

(52) U.S. Cl. CPC H04L 63/0815

(57) ABSTRACT

One object is to provide a simpler setup for a plurality of application programs to share information required for logins with ensured security. In accordance with one aspect, an application program according to an embodiment includes: an authentication information requesting module configured to request an authentication token from another application program used for a login included in login history; a login requesting module configured to request a login to a server using the obtained authentication token; an authentication information storing module configured to newly obtain an authentication token in response to a login and store the authentication token in a storage area for the application program; a login history recording module configured to record into the login history a login using the application program; and an authentication information providing module configured to provide to the other application program the authentication token stored in the storage area for the application program.

### CROSS-REFERENCE TO RELATED APPLICATIONS

This application is based on and claims the benefit of priority from Japanese Patent Application Serial No. 2013-263744 (filed on Dec. 20, 2013), the contents of which are hereby incorporated by reference in their entirety.

### TECHNICAL FIELD

The present invention relates to a login requesting device and method for requesting a login to a server and a program used therefor.

### BACKGROUND

To utilize services provided via a network such as the Internet, users conventionally input information such as a user ID and a password such that login authentication is performed based on the input information. For saving trouble of inputting information such as a user ID and a password, a technique has been proposed wherein a server issues an authentication token for a first login and sends it to a terminal of a user, and the terminal sends the authentication token to the server for later logins such that login authentication is performed (see, e.g., Japanese Patent Application Publication No. 2012-191270). Meanwhile, more users recently install application programs onto terminals such as smartphones for utilizing the above services. In utilizing the services with application programs, it may be possible to log in, with the same information such as a user ID and a password, to a plurality of application programs for services operated by the same administrator. Accordingly, when the plurality of application programs share the above authentication token, it may be possible to further reduce the trouble of inputting information such as a user ID and a password.

However, when a plurality of application programs share the above authentication token, it is required to ensure the security of the authentication token having a high confidentiality. Some operating systems include a special setup for managing highly confidential information (e.g., a setup for managing information such as a user ID and a password using a secure storage area subjected to an encryption process); but such a setup is not common to all the operating systems. If, for example, an authentication token is stored in a nonsecure storage area not subjected to an encryption process and is shared by a plurality of application programs, an application program from a malicious third party may illicitly use the authentication token to accept an unauthorized login. Accordingly, a simpler setup is desired for a plurality of application programs to share an authentication token with ensured security.

### SUMMARY

One object of embodiments of the present invention is to provide a simpler setup for a plurality of application programs to share information required for logins with ensured security. Other objects of the present disclosure will be apparent with reference to the entire description in this specification.

A first program according to an embodiment of the present invention includes a plurality of program modules and is configured to cause a computer to implement functions corresponding to the program modules, the plurality of program modules comprising: an authentication information requesting module configured to refer to login history including history of logins to a server, each of the logins using one of a plurality of predetermined programs executable on the computer, the login history being stored in a predetermined storage area accessible to the computer, and request authentication information to be used for a login to the server from a second program used for the one login included in the login history; and a login requesting module configured to request a login to the server using the authentication information obtained from the second program.

In the first program in the embodiment described above, the plurality of program modules may further comprise: an authentication information storing module configured to newly obtain authentication information from the server in response to a login to the server and store the obtained authentication information into a storage area for the first program managed by the first program and accessible to the computer; and an authentication information providing module configured to provide, to a third program, the authentication information stored in the storage area for the first program in response to a request from the third program. Additionally, the plurality of program modules may further comprise a login history recording module configured to record into the login history a login to the server using the first program, in response to the login to the server.

A method according to an embodiment of the present invention uses a computer for requesting a login to a server, the method comprising the steps of: obtaining, by means of a second program, authentication information used to log in to the server from the server in response to a login to the server using the second program, and storing the obtained authentication information into a storage area for the second program managed by the second program and accessible to the computer; recording, by means of the second program, into login history a login to the server using the second program, in response to the login to the server using the second program, the login history including history of logins to the server, each of the logins using one of a plurality of predetermined programs executable on the computer, the login history being stored in a predetermined storage area accessible to the computer; referring, by means of a first program, to the login history, and requesting the authentication information from the second program used for a login included in the login history; providing, by means of the second program, to the first program the authentication information stored in the storage area for the second program in response to a request from the first program; and requesting, by means of the first program, a login to the server using the authentication information obtained from the second program.

A login requesting device according to an embodiment of the present invention is a login requesting device configured to request a login to a server, the device comprising: an authentication information storing unit configured to obtain, by means of a second program, authentication information used to log in to the server from the server in response to a login to the server using the second program, and store the obtained authentication information into a storage area for the second program managed by the second program and accessible to the computer; a login history recording unit configured to record, by means of the second program, into login history a login to the server using the second program, in response to the login to the server using the second program, the login history including history of logins to the server, each of the logins using one of a plurality of predetermined programs executable on the computer, the login history being stored in a predetermined storage area accessible to the computer; an authentication information requesting unit configured to refer, by means of a first program, to the login history, and request the authentication information from the second program used for a login included in the login history; an authentication information providing unit configured to provide, by means of the second program, to the first program the authentication information stored in the storage area for the second program in response to a request from the first program; and a login requesting unit configured to request, by means of the first program, a login to the server using the authentication information obtained from the second program.

Various embodiments of the present invention provide a simpler setup for a plurality of application programs to share information required for logins with ensured security.

### BRIEF DESCRIPTION OF THE DRAWINGS

FIG. 1 is a block diagram schematically illustrating a network configuration of a system 1 including a terminal 30 according to an embodiment of the present invention.

FIG. 2 is a block diagram schematically illustrating the module arrangement of a program 50 according to an embodiment of the present invention.

FIG. 3 is a diagram showing an example of information managed by login history according to an embodiment.

FIG. 4 is a flow diagram showing an example of a login process according to an embodiment.

### DESCRIPTION OF EXAMPLE EMBODIMENTS

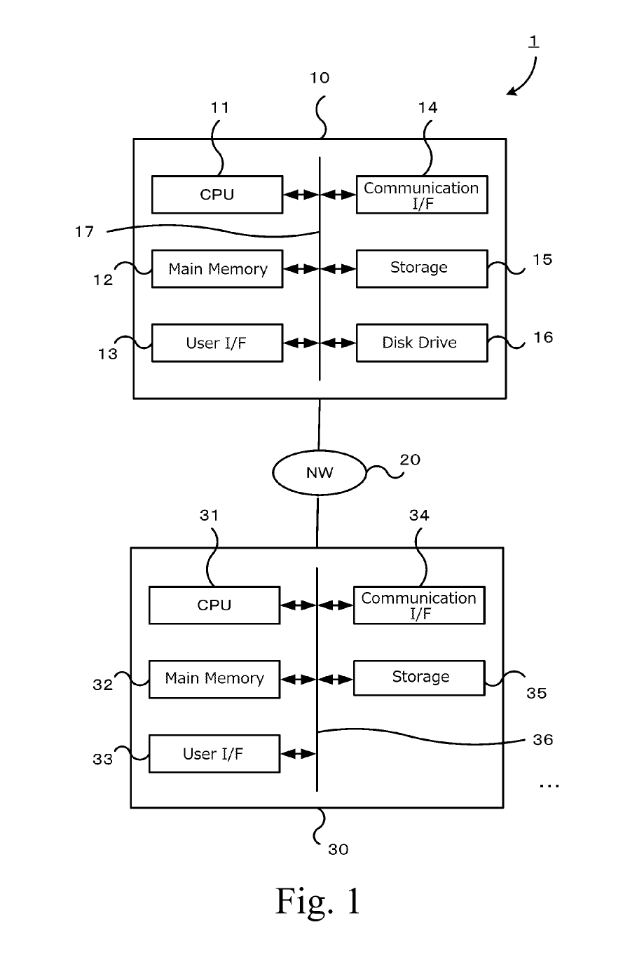

FIG. 1 is a block diagram schematically illustrating a network configuration of a system 1 including a terminal 30 according to an embodiment of the present invention. As shown in FIG. 1, the terminal 30 according to an embodiment may be communicatively connected via a communication network 20 such as the Internet to a server 10 configured as a conventional computer, and a user of the terminal 30 may use various Internet services provided by the server 10. The Internet services provided by the server 10 may include services for providing digital contents such as games, and platform services (SNS services) for implementing various communications between a plurality of users each operating a terminal 30 (e.g., chat (MiniMail), circle, avatar, diary, message board, greeting, telephone call), but are not limited thereto. Further, as will be described later, the terminal 30 may function as a login requesting device according to an embodiment of the present invention that requests a login to the server 10.

As shown, the server 10 may include a central processing unit (CPU) (computer processor) 11, a main memory 12, a user interface (I/F) 13, a communication I/F 14, a storage 15, and a disk drive 16, and these components may be electrically connected to one another via a bus 17. The CPU 11 may load various programs into the main memory 12 from the storage 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminals 30 via the communication network 20.

The storage 15 may be formed of, for example, a magnetic disk drive and store various programs such as a control program for controlling the progress of various services provided by the server 10. The storage 15 may also store various data used in the various services. The various data that may be stored in the storage 15 may also be stored on a database server communicatively connected to the server 10 and physically separate from the server 10. The disk drive 16 may read data stored in a storage medium such as a compact disc read only memory (CD-ROM), digital versatile disc read only memory (DVD-ROM), or DVD Recordable (DVD-R) disc, or write data to such a storage medium.

In an embodiment, the server 10 may function as a web server for managing a web site including a plurality of hierarchical web pages and may be capable of providing the terminal 30 with various services via the web sites. The terminals 30 may fetch HTML data for rendering a web page from the server 10 and analyze the HTML data to present the web page to a user of the terminals 30. For example, a game provided through such a web page is sometimes called a browser game. The storage 15 may also store the HTML data for rendering the web page. The HTML data may comprise HTML documents written in markup languages such as HTML; the HTML documents may be associated with various images. Additionally, the HTML documents may include programs written in various script languages.

The storage 15 may also store applications to be executed on execution environments of the terminal 30 other than browser software. These applications may include programs for performing various processes and various data such as image data to be referred to for executing the programs. The programs may be created in, for example, object oriented languages such as Objective-C™ and Java™. The application stored on the storage 15 may be delivered to a terminal 30 in response to a delivery request. The application delivered from the server 10 may be received by the terminal 30 through a communication I/F 34 in accordance with the control of CPU 31; and the received application may be sent to a storage 35 and stored thereon. The application may be launched in accordance with the user's operation on the terminal 30 and may be executed on an execution environment implemented on the terminal 30 such as ngCore™ or Android™. The server 10 may provide the applications executed on the terminals 30 with various necessary data. Additionally, the server 10 can store various data sent from the terminal 30 for each user, thereby managing the statuses of the various services such as progress of games for each user.

Thus, the server 10 may manage the web site for providing various services and deliver web pages constituting the web site in response to a request from the terminal 30, thereby providing various services. Also, the server 10 can provide various services based on communication with an application performed on the terminal 30 in place of, or in addition to, such browser-based services. Briefly, the server 10 may also include a function to authenticate a user at start of various services and perform charging process in accordance with provision of various services.

In an embodiment, the terminal 30 may be any information processing device that may display on a web browser a web page of a web site obtained from the server 10 and include an application executing environment for executing applications; and the terminals 30 may include personal computers, smartphones, tablet terminals, and game-dedicated terminals.

As shown, the terminal 30 may include a central processing unit (CPU) (computer processor) 31, a main memory 32, a user interface (I/F) 33, a communication I/F 34, and a storage 35, and these components may be electrically connected to one another via a bus 36.

The CPU 31 may load various programs into the main memory 32 from the storage 35, and may execute commands included in the loaded programs. The main memory 32 may be used to store a program to be executed by the CPU 31, and may be formed of, for example, a dynamic random access memory (DRAM).

The user I/F 33 may include an information input device for receiving user inputs and an information output device for outputting an operation result of CPU 31; and the user I/F may include a display device such as a liquid crystal display having a touch panel.

The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The storage 35 may be constituted by, for example, a magnetic disk drive or a flash memory and store various programs such as an operating system and an application program and various data processed by these programs. The storage 35 may include a built-in storage and a removable storage. A removable storage may include, for example, an SD memory card having a built-in flash memory.

A terminal 30 having such an architecture may include, for example, browser software for interpreting HTML data and rendering a screen; this browser software may enable the terminal 30 to interpret the HTML data fetched from the server 10 and render web pages corresponding to the received HTML data. Further, the terminal 30 may include plug-in software embedded into browser software; therefore, the terminal 30 can fetch from the server 10 or another server a SWF file embedded in HTML data and execute the SWF file by using the browser software and the plug-in software.

When browser software or an application program is executed on the terminal 30, for example, animation or an operation icon designated by the program may be displayed on a screen of the terminal 30. A user can input various instructions via a user I/F 33 of the terminal 30. The instruction entered by the user may be transmitted to the server 10 through the browser of the terminal 30 or a function of an execution environment such as ngCore™.

Next, an application program 50 according to an embodiment of the present invention will be described. The application program 50 in an embodiment, which may be used for using various services provided by the server 10, may be executed on a computer such as a terminal 30 to cause the computer to function as a login requesting device that may request a login to the server 10. When a user operating the terminal 30 hopes to use various services provided by the server 10 through the application program 50, the user may download an application program 50 corresponding to a service to be used from the server 10 or another server (e.g., a server that provides delivery services of application programs, movies, music, books) and install the application program 50 into the terminal 30. The installed application program may be stored on the storage 35. Such operation of installing or uninstalling the application program 50 may be achieved primarily by functions of an operating system of the terminal 30. The terminal 30 may have installed thereon a plurality of application programs 50 corresponding to a plurality of services provided by the server 10, respectively and a plurality of application programs other than the application programs 50 (e.g., application programs for using services provided by a server other than the server 10 (services provided by an administrator other than the administrator of the server 10)).

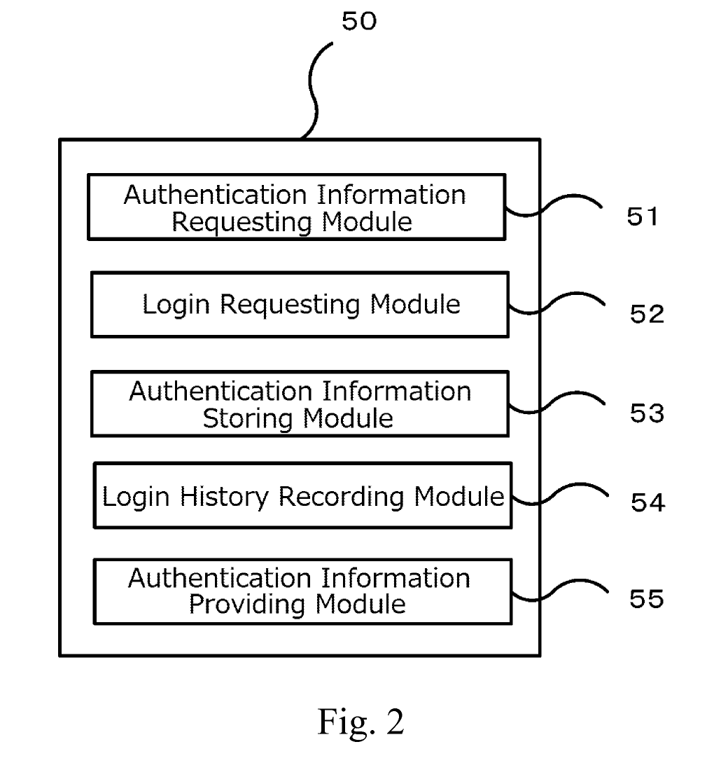

The application program 50 in an embodiment may be constituted by a plurality of program modules. The functions corresponding to these program modules may be implemented by a computer such as the terminal 30. More specifically, when the application program 50 is executed by a CPU 31 (a computer processor) of the terminal 30, the functions corresponding to a plurality of program modules constituting the application program 50 may be implemented by the terminal 30. FIG. 2 is a block diagram showing an example of a plurality of program modules constituting the application program 50. As shown, the application program 50 in an embodiment comprises a plurality of program modules including: an authentication information requesting unit 51 configured to refer to the login history, the login history including history of logins to the server 10, each of the logins using one of a plurality of application programs executable on the terminal 30, the login history being stored in a storage area in a storage 35, etc. accessible to the terminal 30, and request an authentication token (authentication information) to be used for a login to the server 10 from another application program 50 (second program) used for a login included in the login history; a login requesting module 52 configured to request a login to the server 10 using the authentication information obtained from the other application program; an authentication information storing module 53 configured to obtain an authentication token from the server 10 in response to a login to the server 10 and store the obtained authentication token into a storage area for the application program 50 managed by the application program 50 and accessible to the terminal 30; a login history recording module 54 configured to record into the login history a login to the server 10 using the application program 50, in response to the login to the server 10; and an authentication information providing module 55 configured to provide to another application program 50 (third program) the authentication token stored in the storage area for the application program 50 in response to a request from the other application program. As described above, when the CPU 31 executes the application program 50 in an embodiment, the terminal 30 in an embodiment may serve as units corresponding to program modules constituting the application program 50 and serve as, e.g., a login requesting device that requests a login to the server 10. The program modules 51 to 55 described above may be related mainly to a function of requesting a login to the server 10, and the plurality of program modules constituting the application program 50 may include program modules corresponding to functions other than program modules 51 to 55. For example, the application program 50 may include other program modules corresponding to functions (e.g., a function for playing a game) for services to be used through the application program 50 among various services provided by the server 10. If add-on software (such as SDK) including the program modules 51 to 55 is disclosed to developers of application programs, the developers may provide various application programs that function as the application program 50 in an embodiment.

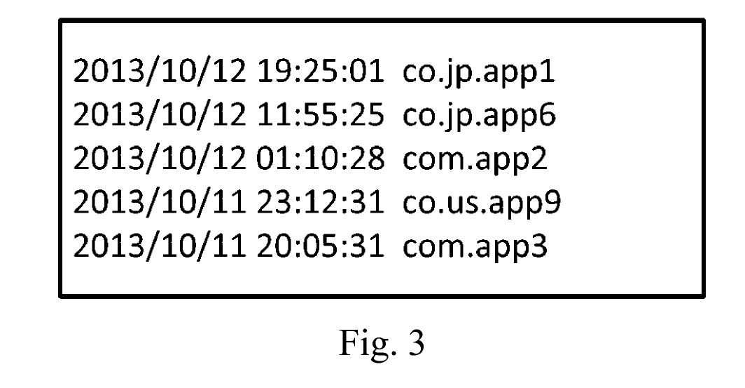

FIG. 3 shows a specific example of information managed by login history stored in a storage area on the storage 35 of the terminal 30 in an embodiment. As shown, the login history in an embodiment may contain login information pieces each constituted by a combination of a login date and time indicating when the login was performed and application specifying information (e.g., an application name or a package name) that specifies an application program used for the login. For example, the login history may manage information on a predetermined number (e.g., one or five) of most recent logins. The storage area for storing the login history may be provided by, e.g., a flash memory built in an SD memory card removably installed on the terminal 30. Since the login history is less confidential than an authentication token used for a login, the login history may be stored on an SD memory card which is a nonsecure area not subjected to an encryption process. As will be described later, the login history may be recorded by the function of a login history recording module 54 of the application program 50 in an embodiment and may not include information on logins through application programs installed on the terminal 30 other than the application program 50.

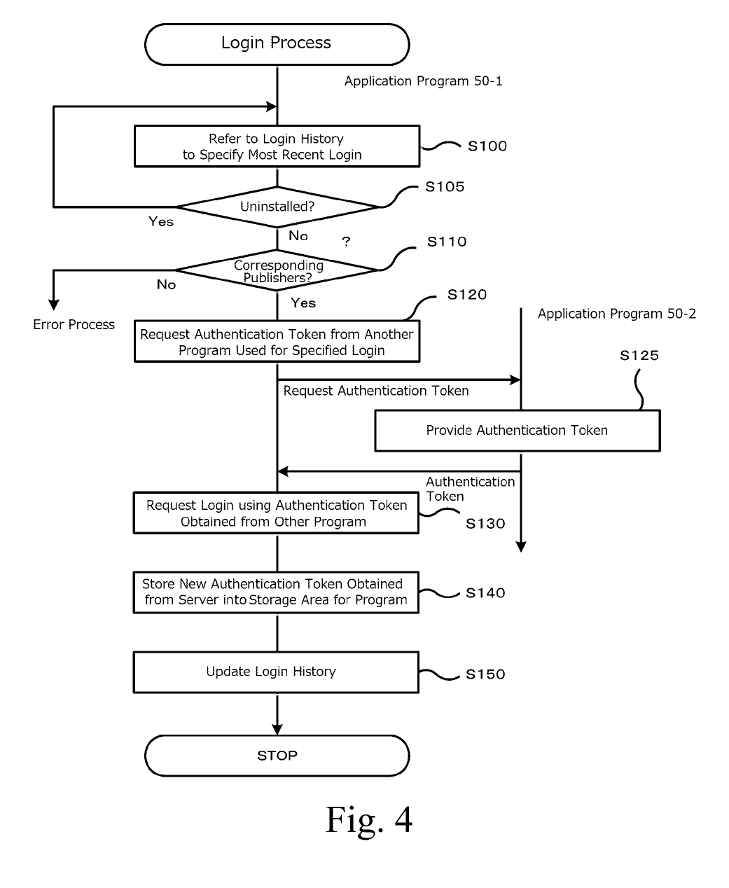

Next, description will be made on operations implemented on the terminal 30 by executing the application program 50 in an embodiment. FIG. 4 is a flow diagram showing an example of a login process performed by the terminal 30 in an embodiment. The login process may be performed when the application program 50 in an embodiment is started. For convenience, the application program 50 which has been started and has triggered a login process is hereinafter referred to as the application program 50-1 (the first program). As shown, the first step of the login process may be to specify the most recent login with reference to the above login history (step S100). This step may correspond to the function of an authentication information requesting module 51. More specifically, the most recent login (with the latest login date and time) may be specified, with reference to the login history stored in the storage area of the storage 35, from among the logins included in the login history.

Then, it is determined whether the application program 50 used for the most recent login specified has been uninstalled (step S105). If it has been uninstalled, the login history is referred to again to specify the second most recent login. This step may correspond to the function of the authentication information requesting module 51. More specifically, it is determined in this step whether the application program used for the login specified in step S100 has been uninstalled based on information on installed application programs managed by the operating system or the like. Thus, in an embodiment, a login using an application program still remaining installed and made at the most recent login date and time may be selected from among a plurality of logins included in the login history.

Then, it is determined whether or not the publisher of the application program 50-1 corresponds to the publisher of the application program 50 used for the specified login (step S110). If not, a predetermined error process may be performed and the login process may be ended. This step may correspond to the function of the authentication information requesting module 51. More specifically, for example, the digital signature of the application program 50-1 may be compared to the digital signature of the application program 50 used for the specified login. If the publishers specified by the digital signatures are the same, it is determined that the publishers correspond to each other; and otherwise, it is determined that the publishers do not correspond to each other. Such a function of comparing digital signatures of application programs may be embedded in the operating system of the terminal 30.

If the publisher of the application program 50-1 corresponds to the publisher of the application program 50 used for the specified login, an authentication token may be requested from the application program 50 (step S120). For convenience, the application program 50 from which an authentication token is requested (the object of request for an authentication token) is hereinafter referred to as the application program 50-2 (the second program). This step may correspond to the function of the authentication information requesting module 51. The authentication token may be authentication information issued from the server 10 when the terminal 30 logs in the server 10 such that later logins are possible without inputting a user ID and a password or the like.

The application program 50-2 from which an authentication token is requested may provide, to the application program 50-1, an authentication token stored in the storage area for the application program 50-2 of the terminal 30 (step S125). This step may correspond to the function of an authentication information providing module 55 of the application program 50-2. The authentication token stored in the storage area for the application program 50-2 was obtained from the server 10 in response to a login to the server 10 when a login process triggered by the execution of the application program 50-2 was performed. The operation of obtaining an authentication token from the server 10 and storing it will be described later. The communication between the application programs 50-1 and 50-2 may be implemented as a background process by using, e.g., inter-program communication control function (e.g., “Binder” in the operating system “Android”) of the operating system for controlling communication between application programs. Since such a process related to inter-program communication (inter-process communication (IPC)) is conventional to those skilled in the art, further detailed description is omitted.

After the application program 50-1 obtains an authentication token from the application program 50-2, the obtained authentication token may be used to request a login to the server 10 (step S130). This step may correspond to the function of an login requesting module 52. More specifically, the obtained authentication token may be sent to the server 10. The server 10, having received the authentication token, may determine whether a login is permitted based on the contents of the authentication token. For example, if the received authentication token has expired or the password has been changed after the authentication token was issued, the token may be determined to be invalid and a login may be rejected. Since such a process related to determination of whether a login is permitted based on an authentication token (login authentication) is conventional to those skilled in the art, further detailed description is omitted.

When a login is permitted by the server 10, the server 10 may issue an authentication token; and the terminal 30 may receive the authentication token from the server 10 and store the received authentication token into the storage area for the application program 50-1 (step S140). This step may correspond to the function of an authentication information storing module 53. In an embodiment, the storage area for the application program 50-1 may be managed by the application program 50-1 located in any area in the storage 35. More specifically, the information stored in the storage area for the application program 50-1 can be accessed only through the application program 50-1 and cannot be accessed through other application programs 50 or application programs other than the application programs 50 in an embodiment.

Then, the login history may be updated (step S150), and the login process may be ended. This step may correspond to the function of a login history recording module 54. More specifically, a record of a login using the application program 50-1 may be added to the login history, the record including the login date and time and the application specifying information that specifies the application program 50-1 (the application name or the package name). In an embodiment, the login history may manage a predetermined number of most recent logins; therefore, the record of the oldest login may be deleted from the login history when a record of a new login is added. After the login process is ended, it may become possible to start using the services associated with the application program 50-1 (for example, an initial screen for using the associated services may be displayed on the terminal 30).

Suppose that, after a login process triggered by the start of the application program 50-1 is ended, a new login process is triggered by another application program 50 (the third application program, which will hereinafter be referred to as the application program 50-3 for convenience). In this case, the login using the application program 50-1 may be specified as the most recent login in step S100; and the application program 50-3 may request an authentication token from the application program 50-1 (step S120). The application program 50-1 from which an authentication token is requested may provide, to the application program 50-3 having made the request, an authentication token stored in the storage area for the application program 50-1 managed by itself (step S125). Thus, in an embodiment, the login history may be updated in response to a login to the server 10; and based on the login history, the newest authentication token may be obtained from the application program 50 used for the most recent login. Login requests can be repeated using the obtained newest authentication token.

If, in the above login process, the application program 50-1 already owns an authentication token (an authentication token is stored in the storage area for the application program 50-1), steps S100 to S125 may be skipped to request a login to the server 10 using the already owned authentication token. Further, if, after a login is requested using the already owned authentication token, it is detected that the owned authentication token is invalid (for example, the server 10 informs the terminal 30 that the authentication token is invalid because the authentication token has expired or the password has been changed), steps S100 to S125 may be performed to obtain an authentication token from another application program 50. If, in steps S100 to S105 of the login process, all of the application programs 50 used for the predetermined number of logins included in the login history have been uninstalled, a different login to the server 10 not using an authentication token (e.g., an ordinary login requiring a user ID and a password to be entered) may be requested.

The application program 50 in an embodiment described above may cause the terminal 30 to refer to the login history, request an authentication token (authentication information) to be used for a login to the server 10 from another application program 50 (the second program) which was used for a login included in the login history, and request a login to the server 10 using the authentication token obtained from the other application program 50. Accordingly, it may be possible to log in using an authentication token obtained from the other application program 50 based on the login history; and thus, the security is ensured as compared to the case where an authentication token is stored in a nonsecure storage area and shared by a plurality of application programs. Additionally, since there is no need of a special setup for managing confidential information, a plurality of application programs can share an authentication token with a simpler setup. That is, the embodiment provides a simpler setup for a plurality of application programs to share information required for logins with ensured security.

The application program 50 in an embodiment causes the terminal 30 to operate such that it does not request or provide an authentication token if the publisher of the application program 50 from which an authentication token is requested does not correspond to the publisher of the application program 50 requesting the authentication token. Therefore, the security is further ensured.

Also, the application program 50 in an embodiment may cause the terminal 30 to operate such that it stores the authentication token obtained from the server 10 into the storage area for the application program 50 managed by the application program 50. Therefore, the security is further ensured.

The application program 50 in an embodiment may specify a login using an application program 50 still remaining installed and made at the most recent login date and time may be specified from among a plurality of logins included in the login history (that is, a login made at a more recent login date and time is more preferential); and since an authentication token may be requested from the application program 50 used for the specified login, it is less likely that the obtained authentication token is invalid after it has expired or its password has been changed.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A computer-readable storage medium storing a first program including a plurality of program modules and configured to cause a computer to implement functions corresponding to the program modules,
the plurality of program modules comprising:
an authentication information requesting module configured to refer to login history including history of logins to a server, each of the logins using one of a plurality of predetermined programs executable on the computer, the login history being stored in a predetermined storage area accessible to the computer, specify one login from among the logins included in the login history by virtue of recentness of each login date and time of the logins, and request authentication information to be used for a login to the server from a second program used for the one login specified; and
a login requesting module configured to request a login to the server using the authentication information obtained from the second program.

2. The computer-readable storage medium storing the first program of claim 1, wherein the authentication information requesting module specifies, from among the logins included in the login history, a login using a program still remaining installed on the computer and made at a most recent date and time as the one login.

3. The computer-readable storage medium storing the first program of claim 2, wherein the authentication information requesting module specifies, from among the logins included in the login history, a login using a program still remaining installed on the computer and made at a most recent date and time as the one login, by determining whether or not each of the programs still remains installed in the order of recentness of the login date and time.

4. The computer-readable storage medium storing the first program of claim 1, wherein the authentication information requesting module does not request the authentication information if a publisher of the second program does not correspond to a publisher of the first program.

5. The computer-readable storage medium storing the first program of claim 4, wherein the authentication information requesting module determines whether or not the publisher of the second program corresponds to the publisher of the first program based on comparison between a digital signature of the first program and a digital signature of the second program.

6. The computer-readable storage medium storing the first program of claim 1, wherein the plurality of program modules further comprising:
an authentication information storing module configured to obtain authentication information from the server in response to a login to the server and store the obtained authentication information into a storage area for the first program managed by the first program and accessible to the computer; and
an authentication information providing module configured to provide, to a third program, the authentication information stored in the storage area for the first program in response to a request from the third program.

7. The computer-readable storage medium storing the first program of claim 6, wherein the authentication information providing module does not provide the authentication information if a publisher of the third program does not correspond to a publisher of the first program.

8. The computer-readable storage medium storing the first program of claim 7, wherein the authentication information providing module determines whether or not the publisher of the third program corresponds to the publisher of the first program based on comparison between a digital signature of the first program and a digital signature of the third program.

9. The computer-readable storage medium storing the first program of claim 1, wherein the plurality of program modules further comprises a login history recording module configured to record into the login history a login to the server using the first program, in response to the login to the server.

10. The computer-readable storage medium storing the first program of claim 1, wherein the predetermined storage area is a nonsecure area not subjected to an encryption process.

11. A method using a computer for requesting a login to a server, the method comprising the steps of:
obtaining, by means of a second program, authentication information used to log in to the server from the server in response to a login to the server using the second program, and storing the obtained authentication information into a storage area for the second program managed by the second program and accessible to the computer;
recording, by means of the second program, into login history a login to the server using the second program, in response to the login to the server using the second program, the login history including history of logins to the server, each of the logins using one of a plurality of predetermined programs executable on the computer, the login history being stored in a predetermined storage area accessible to the computer;
referring, by means of a first program, to the login history, specifying one login from among the logins included in the login history by virtue of recentness of each login date and time of the logins, and requesting the authentication information from the second program used for the one login specified;
providing, by means of the second program, to the first program the authentication information stored in the storage area for the second program in response to a request from the first program; and
requesting, by means of the first program, a login to the server using the authentication information obtained from the second program.

12. A login requesting device for requesting a login to a server, the device comprising:
an authentication information storing unit configured to obtain, by means of a second program, authentication information used to log in to the server from the server in response to a login to the server using the second program, and store the obtained authentication information in a storage area for the second program managed by the second program and accessible to the computer;
a login history recording unit configured to record, by means of the second program, into login history a login to the server using the second program, in response to the login to the server using the second program, the login history including history of logins to the server, each of the logins using one of a plurality of predetermined programs executable on the computer, the login history being stored in a predetermined storage area accessible to the computer;
an authentication information requesting unit configured to refer, by means of a first program, to the login history, specify one login from among the logins included in the login history by virtue of recentness of each login date and time of the logins, and request the authentication information from the second program used for the one login specified;
an authentication information providing unit configured to provide, by means of the second program, to the first program the authentication information stored in the storage area for the second program in response to a request from the first program; and
a login requesting unit configured to request, by means of the first program, a login to the server using the authentication information obtained from the second program.
